(19) United States
(12) Patent Application Publication
(10) Pub. No.: US 2009/0271395 A1
(43) Pub. Date: Oct. 29, 2009

(54) MEDIA FILE SEARCHING SYSTEM AND METHOD FOR A MOBILE PHONE

(75) Inventor: MENG-CHUN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/241,054

(22) Filed: Sep. 30, 2008

(30) Foreign Application Priority Data
Apr. 24, 2008 (CN) 200810301277.2

(51) Int. Cl. G06F 17/30; G06F 7/32

(52) U.S. Cl. 707/5; 708/520; 707/E17.01; 707/E17.014

(57) ABSTRACT

A media file searching system for a mobile phone is disclosed. The system comprises: a capturing module configured for capturing a section of rhythm sung by a user; a character calculating module configured for calculating a characteristic parameter of the section of the rhythm by using a levinson-durbin recursion arithmetic; a relevancy calculating module configured for calculating a relevancy of the calculated characteristic parameter with each characteristic parameter of each of the media files stored in the mobile phone by using a relevancy arithmetic; the relevancy calculating module further configured for searching a matched media file whose characteristic parameter have a highest relevancy with the characteristic parameters of the section of the rhythm; and a media player for playing the searched media file. A corresponding method is also disclosed.

### BACKGROUND

1. Field of the Invention

Embodiments of the present disclosure relate to media file searching systems and methods, and particularly to a media file searching system and method for a mobile phone.

2. Description of Related Art

Currently, mobile phones have many advanced functions and auxiliary functions. The auxiliary functions of the mobile phones typically include such things as phone book systems, ring tones, network settings, short message services, and playing media files.

Usually, users may manually operate the mobile phone to select at least a media file to listen. However, it is not convenient for the users to operate the mobile phones when the users encounter such situations, for example, driving bus.

What is needed, therefore, is a system and method for searching a matched media file stored in the mobile phone when the users are inconvenient to operate the mobile phone directly.

### SUMMARY

In one aspect, the aforementioned needs are satisfied by a media file searching system for a mobile phone. The system comprises: a capturing module configured for capturing a section of rhythm sung by a user; a character calculating module configured for calculating a characteristic parameter of the section of the rhythm by using a levinson-durbin recursion arithmetic; a relevancy calculating module configured for calculating a relevancy of the calculated characteristic parameter with each characteristic parameter of each of the media files stored in the mobile phone by using a relevancy arithmetic; the relevancy calculating module further configured for searching a matched media file whose characteristic parameter have a highest relevancy with the characteristic parameter of the section of the rhythm; and a media player for playing the searched media file.

Other objects, advantages and novel features will become more apparent from the following detailed description of certain embodiments of the present disclosure when taken in conjunction with the accompanying drawings, in which:

### BRIEF DESCRIPTION OF THE DRAWINGS

FIG. 1 is a block diagram of one embodiment a mobile phone including a media file searching system.

FIG. 2 is a block diagram of function modules of the media file searching system.

FIG. 3 is a flowchart of one embodiment of a method for searching a matched media file by using the media file searching system.

FIG. 4 is a schematic diagram illustrating relevancy of one embodiment of a calculated characteristic parameter of a section of rhythm with characteristic parameters of media files stored in the mobile phone.

### DETAILED DESCRIPTION OF CERTAIN INVENTIVE EMBODIMENTS

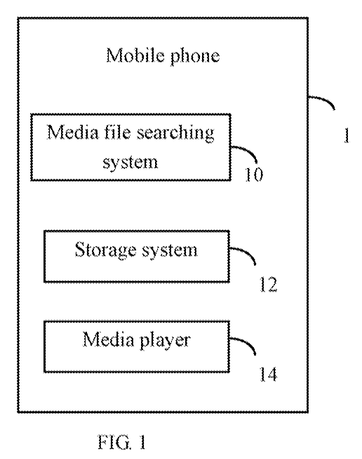

FIG. 1 is a block diagram of one embodiment a mobile phone 1 including a media file searching system 10 and a storage system 12. The media file searching system 10 is configured for searching a matched media file stored in the storage system 12 according to a section of rhythm sung by a user.

The storage system 12 is used for storing data used or generated by using the media file searching system 10, such as a plurality of media files and characteristic parameters of the plurality of media files which may be set as ring tones of the mobile phone 1. Each of the plurality of media files may be stored in the MP3 format or in the musical instrument data interface (MIDI) format. However, it may be understood that other music formats may be used, such as, but not limited to .mp4, .ogg, and .wav.

The mobile phone 1 further includes a media player 14, which may be used to play media files selected by the user.

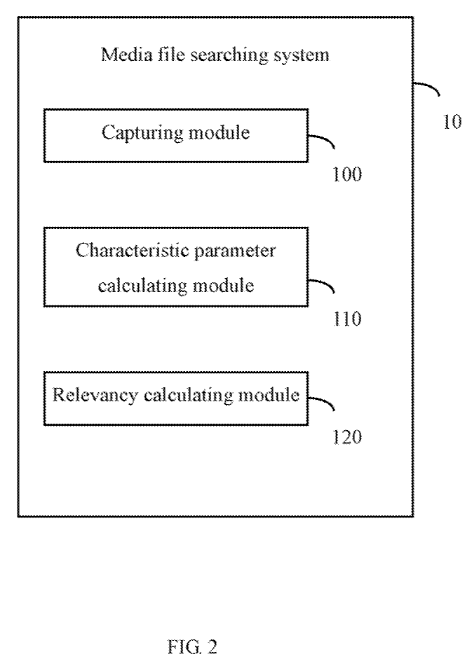

FIG. 2 is a block diagram of function modules of the media file searching system 10. In one embodiment, the media file searching system 10 includes a capturing module 100, a characteristic parameter calculating module 110, and a relevancy calculating module 120. The modules 100, 110, 120 may be used to execute one or more operations of the mobile phone 1. Accordingly, one or more processors may be used to receive data and execute one or more operations for the modules 100, 110, 120.

The capturing module 100 is configured for capturing at least a section of a rhythm sung by the user. The section of the rhythm may be a few second or a few hours depending on the embodiment.

The characteristic parameter calculating module 110 is configured for calculating a characteristic parameter of the section of the rhythm by using a levinson-durbin recursion arithmetic. The levinson-durbin recursion arithmetic is as follows:

\hat{x}(n)=−a(2)x(n−1)−a(3)x(n−2)−L−a(p+1)x(n−p),

e(n)=x(n)−\hat{x}(n);

wherein the \hat{x}(n) is the calculated characteristic parameter of the section of the rhythm sung by the user; p is segment number of the rhythm; x(n) is a rhythm corresponding to each segment of the rhythm; n is a number between 2˜p+1; a(2), L, a(p+1) are coefficients of the segments; and e(n) is a parameter which can be set according to search requirements.

The relevancy calculating module 120 is configured for calculating a relevancy of the calculated characteristic parameter with each characteristic parameter of each of the plurality of media files stored in the storage system 12 by using a relevancy arithmetic. The relevancy arithmetic is as follows:

dist(x,xₜᵣₐᵢₙ)=|x−xₜᵣₐᵢₙ|²,

wherein xₜᵣₐᵢₙ is the characteristic parameter of media files stored in the storage system 12; x is the characteristic parameters of the section of the rhythm sung by the user.

The relevancy calculating module 120 is further configured for searching a matched media file whose characteristic parameter have a highest relevancy with the characteristic parameters of the section of the rhythm. The media player 14 plays the searched media file.

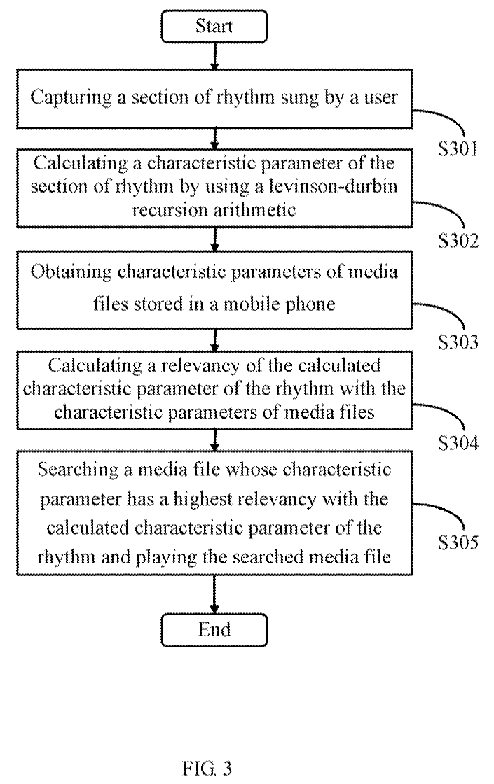

FIG. 3 is a flowchart of one embodiment of a method for searching a matched media file stored in the mobile phone 1 by using the media file searching system 10 of the present disclosure. Depending on the embodiment, additional blocks may be added, others deleted, and the ordering of the blocks may be changed. In block S301, the capturing module 100 captures at least a section of rhythm sung by the user of mobile phone 1.

In block S302, the characteristic parameter calculating module 110 calculates a characteristic parameter of the section of the rhythm by using a levinson-durbin recursion arithmetic. Details of one example of calculating the characteristic parameter of the section of the rhythm is detailed above.

In block S303, the relevancy calculating module 120 obtains characteristic parameters of each media file stored in the storage system 12.

In block S304, the relevancy calculating module 120 calculates a relevancy of the calculated characteristic parameter with each characteristic parameter of each of the media files stored in the mobile phone by using a relevancy arithmetic. The relevancy arithmetic is as described above.

In block S305, the relevancy calculating module 120 is further configured for searching a matched media file whose characteristic parameter have a highest relevancy with the calculated characteristic parameters of the section of the rhythm. Accordingly, the media player 14 plays the searched media file.

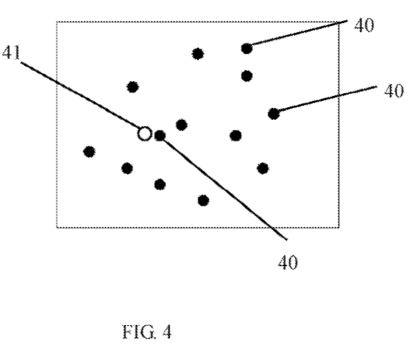

FIG. 4 is a schematic diagram illustrating one embodiment of a relevancy of a calculated characteristic parameters with a section of rhythm with characteristic parameters of media files stored in the mobile phone of the present disclosure. In the illustrated embodiment, there are thirteen characteristic parameters 40 of thirteen media files stored in the storage system 12. The present disclosure can calculates a relevancy of a calculated characteristic parameters 41 of a section of the rhythm sung by the user with thirteen characteristic parameters stored in the storage system 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A media file searching system for a mobile phone, the mobile phone having a storage system for storing a plurality of media files and characteristic parameters of each of the plurality of media files, the system comprising:
a capturing module configured for capturing a section of rhythm sung by a user;
a character calculating module configured for calculating a characteristic parameter of the section of the rhythm by using a levinson-durbin recursion arithmetic;
a relevancy calculating module configured for calculating a relevancy of the calculated characteristic parameter with each characteristic parameter of each of the plurality of media files stored in the storage system by using a relevancy arithmetic;
the relevancy calculating module further configured for searching a matched media file whose characteristic parameter have a highest relevancy with the calculated characteristic parameter of the section of the rhythm; and
a media player for playing the searched media file.

2. The system as claimed in claim 1, wherein the levinson-durbin recursion arithmetic is as follows:
\hat{x}(n)=−a(2)x(n−1)−a(3)x(n−2)−L−a(p+1)x(n−p),
e(n)=x(n)−\hat{x}(n);
wherein the \hat{x}(n) is the calculated characteristic parameter of the section of the rhythm sung by the user; p is segment number of the rhythm; x(n) is a rhythm corresponding to each segment of the rhythm; n is a number between 2˜p+1; a(2), L, a(p+1) are coefficients of the segments; and e(n) is a parameter which may be set according to search requirements.

3. The system as claimed in claim 1, wherein the relevancy arithmetic is as follows:
dist(x,xₜᵣₐᵢₙ)=|x−xₜᵣₐᵢₙ|²,
wherein xₜᵣₐᵢₙ is the characteristic parameter of a media file; x is the calculated characteristic parameter of the section of the rhythm sung by the user.

4. A method for searching media files for a mobile phone, the mobile phone having a storage system for storing a plurality of media files and characteristic parameters of each of the plurality of media files, the method comprising:
capturing a section of rhythm sung by a user;
calculating a characteristic parameter of the section of the rhythm by using a levinson-durbin recursion arithmetic;
calculating a relevancy of the calculated characteristic parameter with each characteristic parameter of each of the plurality of media files stored in the mobile phone by using a relevancy arithmetic; and
searching a matched media file whose characteristic parameter has a highest relevancy with the characteristic parameter of the section of the rhythm, and playing the searched media file.

5. The method as claimed in claim 4, wherein the levinson-durbin recursion arithmetic is as follows:
x(n)=−a(2)x(n−1)−a(3)x(n−2)−L−a(p+1)x(n−p),
e(n)=x(n)−\hat{x}(n);
wherein the \hat{x}(n) is the calculated characteristic parameter of the section of the rhythm sung by the user; p is segment number of the rhythm; x(n) is a rhythm corresponding to each segment of the rhythm; n is a number between 2 p+1; a(2), L, a(p+1) are coefficients of the segments; and e(n) is a parameter which can be set according to search requirements.

6. The method as claimed in claim 4, wherein the relevancy arithmetic is as follows:
dist(x,xₜᵣₐᵢₙ)=|x−xₜᵣₐᵢₙ|²,
wherein xₜᵣₐᵢₙ is the characteristic parameter of a media file; x is the calculated characteristic parameter of the section of the rhythm sung by the user.

7. A storage system medium having stored thereon instructions that, when executed by a mobile phone, causing the mobile phone to perform a method for searching media files for a mobile phone, the method comprising:
providing a storage system for storing a plurality of media files and characteristic parameters of each of the plurality of media files;
capturing a section of rhythm sung by a user;
calculating a characteristic parameter of the section of the rhythm by using a levinson-durbin recursion arithmetic;
calculating a relevancy of the calculated characteristic parameter with each of the characteristic parameters of media files stored in the mobile phone by using a relevancy arithmetic; and
searching a matched media file whose characteristic parameter has the highest relevancy with the characteristic parameters of the section of the rhythm, and playing the searched media file.

8. The storage system medium as claimed in claim 7, wherein the levinson-durbin recursion arithmetic is as follows:
\hat{x}(n)=−a(2)x(n−1)−a(3)x(n−2)−L−a(p+1)x(n−p),
e(n)=x(n)−\hat{x}(n);
wherein the \hat{x}(n) is the calculated characteristic parameter of the section of the rhythm sung by the user; p is segment number of the rhythm; x(n) is a rhythm corresponding to each segment of the rhythm; n is a number between 2 p+1; a(2), L, a(p+1) are coefficients of the segments; and e(n) is a parameter which may be set according to search requirements.

9. The storage system medium as claimed in claim 7, wherein the relevancy arithmetic is as follows:
dist(x,xₜᵣₐᵢₙ)=|x−xₜᵣₐᵢₙ|²,
wherein xₜᵣₐᵢₙ is the characteristic parameter of a media file; x is the calculated characteristic parameter of the section of the rhythm sung by the user.
